(19) United States
(12) Patent Application Publication
(10) Pub. No.: US 2017/0108267 A1
(43) Pub. Date: Apr. 20, 2017

(54) DOMESTIC REFRIGERATION APPLIANCE HAVING AN INTERIOR LIGHTING SYSTEM, AND METHOD FOR OPERATING AN INTERIOR LIGHTING SYSTEM OF A DOMESTIC REFRIGERATION APPLIANCE

(71) Applicant: BSH HAUSGERAETE GMBH, MUENCHEN (DE)

(72) Inventors: BERND OSBAR, AALEN (DE); CHRISTIAN SCHMID, DIETENHEIM (DE); ARMIN WEBER, LAUCHHEIM (DE); MAX EICHER, MUENCHEN (DE); PHILIPP KLEINLEIN, MUENCHEN (DE); ANDREAS DANLER, VOELS (AT); MANFRED GSTREIN, ABSAM (AT); GEORG SEEBACHER, VOELS (AT)

(21) Appl. No.: 15/129,136

(22) PCT Filed: Feb. 27, 2015
(86) PCT No.: PCT/EP2015/054161

§ 371 Date: Sep. 26, 2016

(30) Foreign Application Priority Data
Mar. 27, 2014 (DE) 10 2014 205 727.2

(51) Int. Cl. F25D 27/00; H05B 33/08; H05B 37/02; F25D 11/00

(52) U.S. Cl. CPC F25D 27/005; F25D 11/00; H05B 33/0872; H05B 33/0854; H05B 37/0218

(57) ABSTRACT

A domestic refrigeration appliance includes a thermally insulated body having an internal container which delimits a coolable interior provided for the storage of food, a refrigeration apparatus for cooling the coolable interior space and a door leaf which is provided to close the coolable interior in a closed state and to make the coolable interior accessible in an open state. An interior lighting system includes at least one lighting device for at least partially lighting the coolable interior when the door leaf is open. A light color of light generated by the interior lighting system can be set or adjusted.

The invention relates to a domestic refrigeration appliance with an interior lighting system and a method for operating an interior lighting system of a domestic refrigeration appliance.

Domestic refrigeration appliances comprise a refrigeration apparatus embodied in particular as a refrigerant circuit and a thermally insulated body with a coolable inner container which delimits a coolable interior intended for the storage of food, said interior being cooled by means of the refrigeration apparatus. Domestic refrigeration appliances further comprise a door leaf for opening and closing the coolable interior and an interior lighting system which is activated when the door leaf is opened.

WO 03/010474 A1 discloses a refrigeration appliance with an interior lighting system and a control circuit for controlling the power of the interior lighting system as a function of the intensity of the ambient light and WO 2912/163776 A2 discloses a domestic refrigeration appliance with an interior lighting system which lights the interior with a first color when the door leaf is opened and with a second color when the brightness of the surroundings of the domestic refrigeration appliance is below a predefined value. The first color is darker than the second color.

It is the object of the present invention to specify an improved domestic refrigeration appliance with a coolable interior and an interior lighting system for at least partially lighting the coolable interior.

The object of the invention is achieved by a domestic refrigeration appliance, having a thermally insulated body with an inner container, which delimits a coolable interior provided for the storage of food, a refrigeration apparatus for cooling the coolable interior, a door leaf, which is provided to close the coolable interior in the closed state and to make said coolable interior accessible in the opened state, and an interior lighting system with at least one lighting means for at least partially lighting the coolable interior when the door leaf is opened, it being possible to set the light color of the light generated by the interior lighting system. The door leaf is in particular supported in such a manner that it can be pivoted relative to the body.

The inventive domestic refrigeration appliance comprises the thermally insulated body with the inner container, which delimits the coolable interior. Said interior is cooled by means of the refrigeration apparatus. Said refrigeration apparatus is preferably configured as a refrigeration circuit known in principle to the person skilled in the art and is preferably embodied in such a manner that it cools the coolable interior at least approximately to a predefined temperature. The coolable interior is provided for the storage of food.

The coolable interior can be closed by means of the door leaf. The door leaf is preferably supported in such a manner that it can be pivoted in relation to an axis, which preferably runs vertically. The coolable interior is accessible in the opened state.

The inventive domestic refrigeration appliance is preferably a domestic refrigerator. The coolable interior is then cooled to temperatures above 0° C. The inventive domestic refrigeration appliance can also be a domestic freezer. The coolable interior is then cooled to temperatures below 0° C. However the inventive domestic refrigeration appliance can also be a combined refrigerator/freezer. The inventive domestic refrigeration appliance can have just one coolable interior or a number of coolable interiors, which can each also be closed and opened by means of a door leaf. Each of the coolable interiors can have a separate inventive interior lighting system.

The inventive domestic refrigeration appliance further comprises the interior lighting system, which at least partially lights the coolable interior when the door leaf is opened. The inventive domestic refrigeration appliance can be designed in such a manner that the interior lighting system is deactivated when the door leaf is closed, in other words it is only activated when the door leaf is opened. The inventive domestic refrigeration appliance can have a door opening switch for this eventuality.

The inventive domestic refrigeration appliance can also be configured as a wine chiller cabinet, which is provided to store bottles filled with drinkable liquid, in particular wine. The door leaf is then preferably at least partially transparent, being made for example at least partially of glass. In this instance in particular the interior lighting system can also light the coolable interior when the door leaf is closed.

According to the invention the domestic refrigeration appliance is designed in such a manner that the light color of the light generated by the interior lighting system can be set. This can be performed manually for example. The inventive domestic refrigeration appliance can have a suitable setting apparatus for this eventuality.

Light colors are generally divided into three basic ranges: warm white light with a color temperature below 3,300 K, neutral white light in the range 3,300 to 5,300 K and daylight white light with a color temperature greater than 5,300 K.

The interior lighting system or its lighting means is therefore embodied in such a manner that the generated light can vary in whiteness. For example at least one LED with different light colors or at least one so-called RGB(W) LED (multicolor LED), in particular combining the different light colors within an LED chip, can be used as at least one lighting means.

The color temperature assigned to the light color of the light generated by the interior lighting system is preferably between 2,400 K and 6,500 K.

According to one preferred embodiment of the inventive domestic refrigeration appliance, it is designed to set the light color of the light generated by the interior lighting system as a function of the light of the surroundings of the domestic refrigeration appliance, in particular of the lighting strength and/or the light color of the surroundings of the domestic refrigeration appliance. In order to determine the lighting strength, in other words the brightness or light intensity in the surroundings of the domestic refrigeration appliance and/or the light color of the surroundings, said domestic refrigeration appliance can preferably have a sensor for determining the lighting strength and/or the light color of the surroundings of the domestic refrigeration appliance. The inventive domestic refrigeration appliance is then in particular able to set the light color of the light generated by the interior lighting system as a function of the lighting strength and/or the light color of the surroundings of the domestic refrigeration appliance based on the signals generated by the sensor. The signals from the sensor are in particular electrical signals. If RGB(W) LEDs for example are used as the lighting means, in particular combining the different light colors within an LED chip, the sensor for example can activate said chip directly so that the interior lighting system generates the light, the light color of which is a function of the lighting strength and/or light color of the surroundings.

One example of a suitable sensor is a photocell for example. The sensor or photocell is preferably arranged in or on the outward facing face of the door leaf.

The sensor or photocell can be arranged for example centrally in relation to the side walls of the body in or on the outward facing face of the door leaf. The sensor or photocell can also be arranged in an upper corner in or on the door leaf. It is also possible for the sensor or photocell to be arranged in an outward facing face of the body, in particular in or on its top, for example in one of the corners facing the door leaf. Just one sensor or photocell can be used but a number of sensors or photocells can also be used.

One aspect of the invention relates to a method for operating the interior lighting system of the inventive domestic refrigeration appliance, having the following method steps:
Determining the lighting strength and/or the light color of the light of the surroundings of the domestic refrigeration appliance by means of a sensor for determining the lighting strength and/or the light color of the light of the surroundings of the domestic refrigeration appliance and
Setting the light color of the light generated by the interior lighting system automatically as a function of the lighting strength and/or the light color of the light of the surroundings of the domestic refrigeration appliance based on the signals generated by the sensor.

The inventive domestic refrigeration appliance is preferably designed or provision is made according to the inventive method such that the color temperature assigned to the light color of the light generated by the interior lighting system increases as the lighting strength of the surroundings of the domestic refrigeration appliance increases. According to this variant the inventive domestic refrigeration appliance is therefore designed in such a manner that it activates the interior lighting system automatically based on the signals generated by the sensor such that the color temperature assigned to the light color of the light generated by the interior lighting system increases as the lighting strength of the surroundings of the domestic refrigeration appliance increases.

Provision can therefore be made for the light color of the light of the interior lighting system to have a daylight white light with a color temperature greater than 5,300 K, preferably of approx. 6,500 K, when the lighting strength of the surroundings of the domestic refrigeration appliance corresponds to daytime brightness. For example when the lighting strength of the surroundings of the domestic refrigeration appliance corresponds to dusk or the surroundings are dark, the light of the interior lighting system can have a warm white light with a color temperature of below 3,300 K, in particular preferably of approx. 2,400 K at night. The interior lighting system therefore lights with the daylight white light during the day and/or with the warm white light in the evening or at night.

According to a further embodiment of the inventive domestic refrigeration appliance, said domestic refrigeration appliance is configured to set the light color of the light generated by the interior lighting system automatically according to the light color of the light of the surroundings. According to this variant the domestic refrigeration appliance is therefore designed and according to one variant of the inventive method provision can be made such that the interior lighting system is activated automatically based on the signals generated by the sensor such that the light color of the light generated by the interior lighting system corresponds to the surroundings.

According to a further variant of the inventive domestic refrigeration appliance, said domestic refrigeration appliance can be configured or according to a further variant of the inventive method provision can be made such that the brightness of the light generated by the interior lighting system is set as a function of the lighting strength of the surroundings of the domestic refrigeration appliance, in particular increasing as the lighting strength of the surroundings of the domestic refrigeration appliance increases.

The inventive domestic refrigeration appliance can also be embodied in such a manner that the brightness of the light generated by the interior lighting system is a function of the lighting strength of the surroundings of the domestic refrigeration appliance. In particular the brightness of the interior lighting system increases as the lighting strength of the surroundings of the domestic refrigeration appliance increases. This in particular reduces the risk of a person opening the door leaf of the inventive domestic refrigeration appliance in the dark being dazzled by the interior lighting system.

The inventive domestic refrigeration appliance can preferably be embodied in such a manner that it sets the light color of the light generated by the interior lighting system automatically according to the light color of the surroundings and its brightness based on the lighting strength of the surroundings in particular based on the signals generated by the sensor.

The inventive domestic refrigeration appliance can have a network interface, by way of which for example the domestic refrigeration appliance can be networked to at least one further domestic appliance, in other words being able to communicate with said domestic appliance by way of its network interface. The domestic refrigeration appliance is then preferably designed to receive information about a light color by way of the network interface in order to set the light color of the light generated by the interior lighting system correspondingly. The light color of the light of the interior lighting system of the domestic refrigeration appliance can then be set by way of a network.

One aspect of the invention relates to a system, having the inventive domestic refrigeration appliance and at least one domestic appliance, which has a network interface and a lighting system, the domestic appliance being designed in such a manner that the light color of the light generated by the lighting system can be set. The domestic refrigeration appliance also comprises a network interface so that in particular the domestic appliance and the domestic refrigeration appliance are able to communicate with one another by way of their network interfaces.

The domestic appliance can be any domestic appliance, for example a further domestic refrigeration appliance with a coolable interior. The lighting system is then preferably also an interior lighting system for lighting the coolable interior.

It is for example possible for the inventive domestic refrigeration appliance and the domestic appliance each to receive information about a light color by way of their network interfaces so that the domestic refrigeration appliance can set the light color of the light generated by the interior lighting system and the domestic appliance can set the light color of the light generated by the lighting system correspondingly. The light color of the light of the interior lighting system of the domestic refrigeration appliance and the light color of the light of the lighting system can then be set by way of a network. It is thus possible for example for at least two networked domestic appliances, one of which is the inventive domestic refrigeration appliance, to communicate with one another in such a manner that the light of lighting systems of the domestic appliances has the same light color.

Provision can preferably be made for the domestic appliance to be designed to transmit information about a light color to the domestic refrigeration appliance by way of the network interfaces so that the domestic refrigeration appliance can set the light color of the light generated by the interior lighting system correspondingly. In this instance provision can be made for the domestic appliance to determine the light color of the light of the surroundings for example by means of at least one sensor. Provision can then be made for the domestic appliance to set the light color of the light generated by the lighting system automatically according to the light color of the light of the surroundings and to transmit information about the light color of the light of the surroundings to the domestic refrigeration appliance so that it can set the light color of the light of the interior lighting system automatically in a corresponding manner. This is a relatively simple way of ensuring that the lighting systems of the domestic appliance and the domestic refrigeration appliance generate light of the same light color which is also tailored to the light color of the light of the surroundings of the domestic refrigeration appliance or the domestic appliance.

It is also possible for the domestic refrigeration appliance to be designed to transmit information about a light color to the domestic appliance by way of the network interfaces so that the domestic appliance sets the light color of the light generated by the lighting system correspondingly. In this instance provision can be made for the domestic refrigeration appliance to determine the light color of the surroundings for example by means of at least one sensor. Provision can then be made for the domestic refrigeration appliance to set the light color of the light generated by the interior lighting system automatically according to the light color of the light of the surroundings and to transmit information about the light color of the light of the surroundings to the domestic appliance so that it sets the light color of the light of the lighting system correspondingly. This is also a relatively simple way of ensuring that the lighting systems of the domestic appliance and the domestic refrigeration appliance generate light of the same light color which is also tailored to the light color of the light of the surroundings of the domestic refrigeration appliance or the domestic appliance.

The inventive method can therefore have the following method steps:
Transmitting information about the determined light color of the light of the surroundings of the domestic refrigeration appliance to at least one domestic appliance in particular by way of network interfaces of the domestic refrigeration appliance and the domestic appliance and
Setting a lighting system of the domestic appliance automatically in such a manner that the light color of the light generated by the lighting system corresponds to the transmitted light color.

Depending on the embodiment of the inventive domestic refrigeration appliance it preferably offers automatic tailoring of the light color and preferably also the intensity of the interior lighting system to the ambient conditions during the day, night and/or at dusk.

The lighting strength of the surroundings of the domestic refrigeration appliance, which is preferably configured as a domestic refrigerator, can also preferably be measured by means of the sensor, which is configured for example as a photocell. The sensor here should preferably be positioned in such a manner that it can detect the lighting strength in front of the domestic refrigeration appliance at its installation site. Positioning within the door leaf or on the upper face of the appliance is particularly favorable for this purpose. In the case of domestic refrigeration appliances with an electronic door system the sensor can also be accommodated there. The value determined by the sensor allows a relatively good, if not entirely optimal, value as required for the eye and human sight to be determined for the light intensity within the domestic refrigeration appliance in order to set the interior lighting system automatically in a corresponding manner. It also allows the light color to be tailored to ambient brightness. For such tailoring to the surroundings a lighting means can preferably be used for the interior lighting system, which can generate the desired light color. Suitable lightings means are for example LEDs with different light colors or so-called RGB(W) LEDs, which combine the different light colors within an LED chip.

One advantage of the inventive domestic refrigeration appliance can be seen as being improved, if not entirely optimal, tailoring of the light color and in some instances also the intensity of the light of the interior lighting system to the surroundings of the domestic refrigeration appliance and the resulting improved adaptation properties of the human eye and the subjective perception of the domestic refrigeration appliance illumination. The human eye has the pupil regulation mechanism at its disposal for adjustment to brightness. The pupil is narrowed by the iris as brightness increases and opened further as brightness decreases. Excessive brightness changes result in longer adjustment times for the different light density levels. The introduction of such tailoring shortens such adjustment time for a person using the domestic refrigeration appliance, thereby improving such a user's perception of the domestic refrigeration appliance and its integration into the surroundings. This effect can be further improved by tailoring the light color. Thus during the day a relatively high light color tailored to daylight with for example a color temperature of 6,500 K is preferably set, being corrected downward as dusk progresses to night. During the night the light color can be set to up to 2,400 K to assist the hormone melatonin, which helps regulate the circadian rhythms in the body.

Exemplary embodiments of the invention are illustrated by way of example in the accompanying schematic drawings, in which:

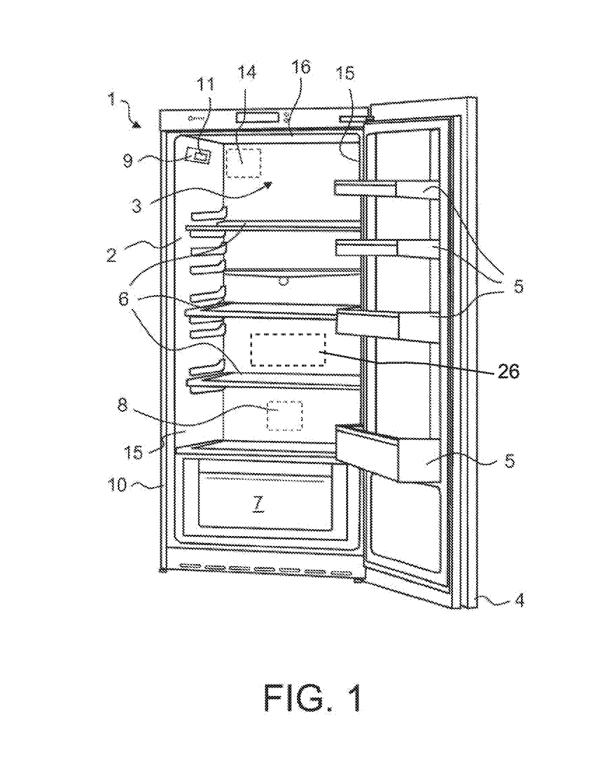

FIG. 1 shows a perspective view of a domestic refrigeration appliance with a coolable interior and a door leaf provided to open and close the coolable interior and shown opened, and

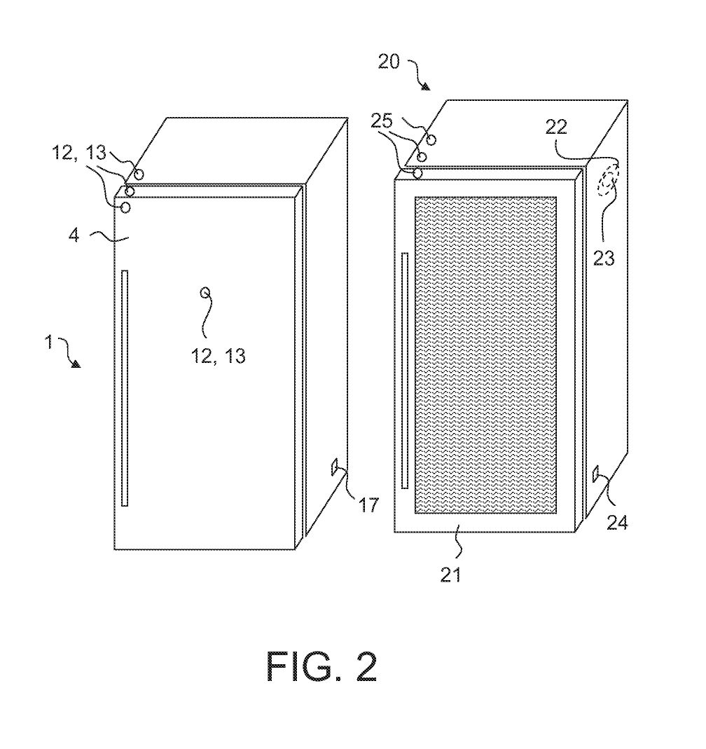

FIG. 2 shows a perspective view of the domestic refrigeration appliance with the door leaf closed and a further domestic appliance.

FIGS. 1 and 2 show perspective views of a domestic refrigeration appliance 1, which comprises a thermally insulated body 10 with an inner container 2, which delimits a coolable interior 3. The coolable interior 3 is provided for the storage of food (not shown in detail). The body 10 in particular comprises two side walls 15 and a top 16.

In the present exemplary embodiment the domestic refrigeration appliance 1 has a pivotable door leaf 4 for closing the coolable interior 3. The door leaf 4 is supported in such a manner that it can be pivoted in particular in relation to an axis running vertically. When the door leaf 4 is opened, as shown in FIG. 1, the coolable interior 3 is accessible. The domestic refrigeration appliance 1 is shown with a closed door leaf 4 in FIG. 2.

In the present exemplary embodiment a number of door shelves 5 for the storage of food are arranged on the face of the door leaf 4 facing in the direction of the coolable interior 3. A number of shelves 6 for the storage of food are arranged in particular in the coolable interior 3 and a drawer 7 in particular is arranged in the lower region of the coolable interior 3, also for the storage of food.

The domestic refrigeration appliance 1 comprises a refrigeration apparatus (not shown in detail) as known in principle to the person skilled in the art, preferably in the form of a refrigerant circuit for cooling the coolable interior 3. The refrigerant circuit comprises for example a compressor, a condenser downstream of the compressor, a throttle apparatus downstream of the condenser, embodied in particular as a throttle or capillary tube, and an evaporator arranged between the throttle apparatus and the compressor.

The domestic refrigeration appliance 1 is for example a domestic refrigerator and/or can be embodied as what is referred to as a no-frost domestic refrigeration appliance. The domestic refrigeration appliance 1 can also be configured as what is known as a wine chiller cabinet. The food in question is then bottles filled with wine or some other drinkable liquid. In this instance the door leaf 4 preferably at least partially transparent. It is made at least partially of glass for example. Provision is then preferably made for there to be no door shelves 5 arranged on the door leaf 4.

In the present exemplary embodiment the domestic refrigeration appliance 1 has a control apparatus 8, which comprises an electronic unit for example and is designed to activate the refrigeration apparatus, in particular the compressor of the refrigerant circuit, in a manner generally known to the person skilled in the art such that the coolable interior 3 has at least approximately a predefined or predefinable setpoint temperature. The control apparatus 8 is preferably designed in such a manner that it regulates the temperature of the coolable interior 3. In order optionally to determine the actual temperature of the coolable interior 3, the domestic refrigeration appliance 1 can have at least one temperature sensor (not shown in detail) connected to the control apparatus 8.

In the present exemplary embodiment the domestic refrigeration appliance 1 comprises an interior lighting system 9 with at least one lighting means 11, which generates a light to light the coolable interior 3 at least partially when the interior lighting system 9 is activated. The interior lighting system 9 is deactivated when the door leaf 4 is closed. To identify this state, the domestic refrigeration appliance 1 can comprise a door opening switch (not shown in detail) as known in principle to the person skilled in the art so the interior lighting system 9 is only activated when the door leaf 4 is opened. In the case of the wine chiller cabinet in particular the interior lighting system 9 can also be activated when the door leaf 4 is closed.

The domestic refrigeration appliance 1 is also embodied in such a manner that it sets the light color of the light generated by the at least one lighting means 11 automatically as a function of the brightness or lighting strength and/or the light color of the surroundings of the domestic refrigeration appliance 1. The light emitted by a lighting means or the light of the surroundings has an inherent color, referred to as the light color, which is defined by color temperature in Kelvin. The higher this temperature, the whiter the light color.

Light colors are generally divided into three basic ranges: warm white light with a color temperature of below 3,300 K, neutral white light in the range 3,300 to 5,300 K and daylight white light with a color temperature greater than 5,300 K.

The interior lighting system 9 or its lighting means 11 is therefore embodied in such a manner that the light it emits can vary in whiteness depending on the brightness or lighting strength and/or light color of the surroundings of the domestic refrigeration appliance 1. At least one LED with different light colors for example or at least one so-called RGB(W) LED, in particular combining the different light colors within an LED chip, is used as at least one lighting means 11.

To determine the brightness or lighting strength and/or the light color of the surroundings of the domestic refrigeration appliance 1, the latter can comprise a least one sensor 12 for detecting the brightness or lighting strength and/or light color of the surroundings of the domestic refrigeration appliance 1.

The sensor 12 of the domestic refrigeration appliance 1 is preferably embodied as at least one photocell 13 or comprises at least one photocell 13.

The sensor 12 or photocell 13 is preferably arranged in or on the outward facing face of the door leaf 4.

The sensor 12 or photocell 13 can be arranged for example centrally in relation to the side walls 15 of the body 10 in or on the outward facing face of the door leaf 4. The sensor 12 or photocell 13 can also be arranged in an upper corner in or on the door leaf 4. It is also possible for the sensor 12 or photocell 13 to be arranged in the outward facing face of the body 10, in particular the top 16, for example in one of the corners facing the door leaf 4.

In the present exemplary embodiment the domestic refrigeration appliance 1 has an apparatus 14 connected to the at least one sensor 12 for setting the light color of the interior lighting system 9 or of the lighting means 11. Said apparatus 14 comprises an electronic unit and activates the interior lighting system 9 or the lighting means 11 based on the signals generated by the sensor 12 or based on the brightness or lighting strength and/or light color of the surroundings of the domestic refrigeration appliance 1 as measured by the sensor 12, in such a manner that it generates a light color as a function of the brightness or lighting strength and/or the light color of the surroundings of the domestic refrigeration appliance 1. The apparatus 14 for setting the light color of the interior lighting system 9 or of the lighting means 11 can also be part of the control apparatus 8 or part of the LED chip, if used.

In the present exemplary embodiment provision is made in particular for the color temperature of the light generated by the interior lighting system 9 to increase as the brightness or lighting strength of the surroundings of the domestic refrigeration appliance 1 increases. When for example the brightness or lighting strength of the surroundings of the domestic refrigeration appliance 1 corresponds to the brightness during the day, the interior lighting system 9 for example is set in such a manner that the light color of the light has a daylight white light with a color temperature greater than 5,300 K, preferably of approx. 6,500 K. In darker surroundings the light of the interior lighting system 9 has a lower light color. For example when the brightness of the surroundings corresponds to dusk or even when said surroundings are absolutely dark, the light of the interior lighting system 9 has a warm white light with a color temperature of below 3,300 K, preferably of approx. 2,400 K.

The domestic refrigeration appliance 1 can also be configured to set the light color of the light generated by the interior lighting system 9 automatically according to the light color of the surroundings. The domestic refrigeration appliance 1 is therefore preferably designed in such a manner that it activates the interior lighting system 9 automatically based on the signals generated by the sensor 12 in such a manner that the light color of the light generated by the interior lighting system 9 corresponds to the surroundings.

Provision can also be made for the brightness of the light generated by the at least one lighting means 11 to be a function of the brightness or lighting strength of the surroundings of the domestic refrigeration appliance 1. Provision is made in particular for the brightness of the light generated by the at least one lighting means 11 to increase, the brighter the surroundings of the domestic refrigeration appliance 1.

The domestic refrigeration appliance 1 can have a network interface 17, by way of which for example the domestic refrigeration appliance 1 can be networked to at least one further domestic appliance, in other words is able to communicate with said domestic appliance by way of its network interface 17. The domestic refrigeration appliance 1 is then preferably designed to receive information about a light color by way of the network interface 17 in order to set the light color of the light generated by the interior lighting system 9 correspondingly. In this instance the light color of the light of the interior lighting system 9 of the domestic refrigeration appliance 1 can be set by way of a network.

FIG. 2 shows a further domestic refrigeration appliance 20 as an example of such a domestic appliance. Like the domestic refrigeration appliance 1, the further domestic refrigeration appliance 20 also comprises a coolable interior, a door leaf 21 for opening and closing the coolable interior, a refrigeration apparatus for cooling the coolable interior and an electronic control apparatus, which is designed to activate, preferably to regulate, the refrigeration apparatus in such a manner that the coolable interior has approximately a predefined setpoint temperature.

In the present exemplary embodiment the further domestic refrigeration appliance 20 is configured as a wine chiller cabinet and its door leaf 21 has an at least partially transparent pane so that the bottles stored in the coolable interior can be viewed through the closed door leaf 21.

The further domestic refrigeration appliance 20 comprises a lighting system, which is embodied in particular as an interior lighting system 22. The interior lighting system 22 comprises a lighting means 23 and is provided to light the coolable interior even when the door leaf 21 is closed.

The further domestic refrigeration appliance 20 is also embodied in such a manner that the light color of the light generated by the at least one lighting means 23 can be set.

The further domestic refrigeration appliance 20 comprises a network interface 24. The domestic refrigeration appliance 1 and the further domestic refrigeration appliance 20 are preferably embodied in such a manner that they can communicate with one another by way of their network interfaces 17, 24.

In the present exemplary embodiment provision is made for the domestic refrigeration appliance 1 to transmit information about a light color to the further domestic refrigeration appliance 20 by way of the network interfaces 17, 24 so that the further domestic refrigeration appliance 20 sets the light color of the light generated by its interior lighting system 22 automatically in a corresponding manner. The light color is preferably the light color of the light of the surroundings, which the domestic refrigeration appliance 1 has determined by means of its sensors 12. This is a relatively simple way of ensuring that the interior lighting systems 9, 23 of the domestic refrigeration appliances 1, 20 each generate light of the same light color, which is also tailored to the light color of the light of the surroundings.

Provision can also be made for the further domestic refrigeration appliance 20 to transmit information about a light color to the domestic refrigeration appliance 1 by way of the network interfaces 17, 24 so that the domestic refrigeration appliance 1 sets the light color of the light generated by its interior lighting system 9 in a corresponding manner. The light color is preferably the light color of the light of the surroundings, which the further domestic refrigeration appliance 20 has determined for example by means of appropriate sensors 24. This is a relatively simple way of ensuring that the interior lighting systems 9, 23 of the domestic refrigeration appliances 1, 20 each generate light of the same light color, which is also tailored to the light color of the light of the surroundings.

Provision can also be made for it to be possible to set the light color and/or brightness of the interior lighting system 9 or of the at least one lighting means 11 manually. In this instance the domestic refrigeration appliance 1 comprises corresponding input means.

### LIST OF REFERENCE CHARACTERS

1 Domestic refrigeration appliance
2 Inner container
3 Coolable interior
4 Door leaf
5 Door shelves
6 Shelves
7 Drawer
8 Control apparatus
9 Interior lighting system
10 Body
11 Lighting means
12 Sensor
13 Photocell
14 Apparatus
15 Side walls
16 Top
17 Network interface
20 Domestic refrigeration appliance
21 Door leaf
22 Interior lighting system
23 Lighting means
24 Network interface
25 Sensors

1-14. (canceled)

15. A domestic refrigeration appliance, comprising:
a thermally insulated body having an inner container delimiting a coolable interior for a storage of food;
a refrigeration apparatus for cooling said coolable interior;
a door leaf being supported relative to said body for closing said coolable interior in a closed state and making said coolable interior accessible in an opened state; and
an interior lighting system having at least one lighting device for at least partially lighting said coolable interior when said door leaf is in said opened state;
said interior lighting system generating light having an adjustable light color.

16. The domestic refrigeration appliance according to claim 15, wherein said door leaf is pivotably supported relative to said body.

17. The domestic refrigeration appliance according to claim 15, wherein the light color of the light generated by said interior lighting system is assigned a color temperature between 2,400 K and 6,500 K.

18. The domestic refrigeration appliance according to claim 15, wherein the light color of the light generated by said interior lighting system is set automatically as a function of the light of surroundings of the domestic refrigeration appliance.

19. The domestic refrigeration appliance according to claim 19, wherein the light color of the light generated by said interior lighting system is set automatically as a function of at least one of a lighting strength or the light color of the light of the surroundings of the domestic refrigeration appliance.

20. The domestic refrigeration appliance according to claim 19, which further comprises a sensor generating signals for determining at least one of the lighting strength or the light color of the light of the surroundings of the domestic refrigeration appliance, to permit the domestic refrigeration appliance to automatically set the light color of the light generated by said interior lighting system as a function of at least one of the lighting strength or the light color of the light of the surroundings of the domestic refrigeration appliance based on the signals generated by said sensor.

21. The domestic refrigeration appliance according to claim 19, wherein the color temperature assigned to the light color of the light generated by said interior lighting system increases as the lighting strength of the surroundings of the domestic refrigeration appliance increases.

22. The domestic refrigeration appliance according to claim 19, wherein the light color of the light generated by said interior lighting system corresponds to the light color of the light of the surroundings.

23. The domestic refrigeration appliance according to claim 17, wherein:
when the lighting strength of the surroundings of the domestic refrigeration appliance corresponds to the brightness during the day, the light color of the light of said interior lighting system has a daylight white light with a color temperature greater than 5,300 K,
and/or
when the lighting strength of the surroundings of the domestic refrigeration appliance corresponds to dusk or when the surroundings are dark, the light of said interior lighting system (9) has a warm white light with a color temperature below 3,300 K.

24. The domestic refrigeration appliance according to claim 23, wherein the color temperature greater than 5,300 K is approximately 6,500 K, and the color temperature below 3,300 K is approximately 2,400 K.

25. The domestic refrigeration appliance according to claim 19, wherein the brightness of the light generated by said interior lighting system is set as a function of the lighting strength of the surroundings of the domestic refrigeration appliance.

26. The domestic refrigeration appliance according to claim 25, wherein the brightness of the light generated by said interior lighting system is set to increase as the lighting strength of the surroundings of the domestic refrigeration appliance increases.

27. The domestic refrigeration appliance according to claim 15, which further comprises a network interface for receiving information about a light color in order to correspondingly set the light color of the light generated by said interior lighting system.

28. A system, comprising:
a domestic refrigeration appliance according to claim 27; and
at least one further domestic appliance having a network interface and a lighting system, said lighting system being configured to set a light color of light generated by said lighting system;
said domestic refrigeration appliance and said further domestic appliance being able to communicate with one another by using said network interfaces.

29. The system according to claim 28, wherein:
said further domestic appliance is configured to transmit information about a light color to said domestic refrigeration appliance by using said network interfaces to permit said domestic refrigeration appliance to set the light color of the light generated by said interior lighting system automatically in a corresponding manner,
and/or
said domestic refrigeration appliance is configured to transmit information about a light color to said further domestic appliance by using said network interfaces to permit said further domestic appliance to set the light color of the light generated by said lighting system automatically in a corresponding manner.

30. A method for operating an interior lighting system of a domestic refrigeration appliance, the method comprising the following steps:
providing a domestic refrigeration appliance including a thermally insulated body having an inner container delimiting a coolable interior for a storage of food, a refrigeration apparatus for cooling the coolable interior, a door leaf being supported relative to the body for closing the coolable interior in a closed state and making the coolable interior accessible in an opened state, and an interior lighting system having at least one lighting device for at least partially lighting the coolable interior when the door leaf is in the opened state, the interior lighting system generating light having an adjustable light color;
determining at least one of a lighting strength or a light color of light of the surroundings of the domestic refrigeration appliance by using a sensor generating signals for determining at least one of the lighting strength or the light color of the light of the surroundings of the domestic refrigeration appliance; and
setting the light color of the light generated by the interior lighting system automatically as a function of at least one of the lighting strength or the light color of the light of the surroundings of the domestic refrigeration appliance based on the signals generated by the sensor.

31. The method according to claim 30, which further comprises automatically setting the light color of the light generated by the interior lighting system based on the signals generated by the sensor so that the light color of the light generated by the interior lighting system corresponds to the light color of the light of the surroundings.

32. The method according to claim 30, which further comprises:
transmitting information about the determined light color of the light of the surroundings of the domestic refrigeration appliance to at least one further domestic appliance; and
setting a lighting system of the at least one further domestic appliance automatically to cause the light color of the light generated by the lighting system to correspond to the transmitted light color.

33. The method according to claim 32, which further comprises carrying out the transmitting step by using network interfaces of the domestic refrigeration appliance and the at least one further domestic appliance.
